(19) United States
(12) Patent Application Publication
(10) Pub. No.: US 2008/0241345 A1
(43) Pub. Date: Oct. 2, 2008

(54) Faux peanut butter

(76) Inventors: Nando Silenzi, Williamsville, NY (US); Dean O'Brien, Lockport, NY (US)

Correspondence Address: WILLIAM J. CROSSETTA, JR., 4135 DAVID COURT, WILLIAMSVILLE, NY, 14221, US

(21) Appl. No.: 12/080,068

(22) Filed: Mar. 31, 2008

Related U.S. Application Data
(60) Provisional application No. 60/909,608, filed on Apr. 2, 2007.

(51) Int. Cl. A23L 1/20

(52) U.S. Cl. 426/634; 426/482

(57) ABSTRACT

A novel non-allergenic composition is disclosed comprising about 20% to about 60% by weight of peas, from about 4% to about 10% by weight palm oil, from about 1% to about 10% by weight powdered sugar, and from about 20% to about 40% by weight Canola oil flavoring component, which forms a spreadable, imitation peanut butter that comprises no peanuts, no tree nuts, no milk, no glutton and looks, tastes, smells and spreads like common peanut butter.

The present invention relates to a composition formed from common naturally available organic materials which, when appropriately combined, form a viscous composition that looks, smells and tastes like commercially available common peanut butter, but does not contain the allergens associated therewith. This is a continuation of Provision Application 60/909,608 filed Apr. 2, 2007.

### BACKGROUND OF THE INVENTION

Peanut butter is a fundamental food of the world's population, yet many children and adults, who contact, ingest, or even smell peanut butter, have threatening allergic reactions thereto. Such reactions are so life threatening that individuals subject to them must avoid even being in the same room with someone eating or having an open container thereof. Peanut butter sandwiches are a delectable staple of adults and children alike, but the fear of life threatening allergen reactions has caused schools and many other places where children gather, to avoid unexpected contact by banning the presence of peanut butter where allergic reactions may be problematic.

Janet Kanters discloses in the Fall 2002 issue of Food For Thought Magazine, efforts to produce an imitation peanut butter made from non-nut containing peas using Canola oil in the process, that does not appear to have a combination of ingredients that so mimics the smell, look, taste and spreading viscosity of commonly available peanut butter spreads, to have been commercially successful as a desirable retail product.

### SUMMARY OF THE INVENTION

The present invention comprises a novel composition of ingredients and method of combining thereof to prepare a faux peanut butter having the desirable smell, flavor, spreadability and look of ordinary peanut butter, but not comprising the allergens thereof.

Generally, the combination of ingredients of the composition may include any combination of ingredients which comprises: peas; one or more sweeteners, artificial or natural, or combination thereof; one or more binders or combination thereof; one or more flavoring components or combination thereof; and, one or more viscosity controlling components or combination thereof. In a preferred embodiment of the present invention, the flavoring component comprises canola oil and the viscosity controlling component is selected from palm oil, palm kernel oil and combinations thereof.

Generally, any non-allergenic pea which grows above ground can be used in the composition of the invention, though brown peas, particularly Chickpeas, generally known as the Garbanzo, and solido brown peas, are preferred. The composition generally comprises: from about 20%-60% by weight peas; about 20%-40% by weight flavoring ingredient; about 4%-10% by weight binder; and about 1%-10% by weight sweetener. To achieve a more accurate mimicking of peanut butter, peas comprise from about 30%-50% by weight of the composition and preferably from about 40%-45% by weight. In a 42%-44% by weight peas.

The flavoring ingredient is added to the peas in a quantity from about 20% to about 40% by weight of the composition. The flavoring ingredient generally comprises a vegetable oil, but may comprise additional components. In a preferred embodiment, the flavoring ingredient comprises Canola oil in an amount from about 30-40% by weight of the composition.

The composition further generally comprises from about 4%-10% by weight binder. The binder is preferably an oil such as palm oil and/or palm kernel oil and the like. The use of palm oils as a binder unexpectedly benefits viscosity control of the composition by providing a look, smell and spreadability of the composition which closely mimics that of common peanut butter, including resisting oil separation of the composition at temperatures below about 100 degrees Fahrenheit.

Sweetener is generally added as a portion of the composition in amounts from about 1%-10% by weight of the composition. In a preferred embodiment, about 5-9% by weight sweetener is added to the composition. In a preferred embodiment, a sweetener that functions as both sweetener and binder is added. In such preferred embodiment no separate binder may be necessary.

The faux peanut butter of the invention can be formulated using any pea excluding nuts. The pea is roasted or cooked to a brown/tan color and dry texture. Once the pea is roasted or cooked and dried, the pea is ground and/or milled to a fine powder. The use of solido brown pea is preferred for color and texture. In a preferred embodiment, solido brown peas are husked and roasted to a brown or tan color and dried. The dried brown pea is then ground and/or milled to a very fine powder.

Any suitable vegetable oil can be used as a flavoring ingredient, however, for the use in the faux peanut butter as a natural, hypo allergenic substance, canola oil is preferred.

A wide variety of sweeteners can be used in the composition. Brown sugar, white bleached sugar or dextrose can be used. However, for the purpose of the faux peanut butter as a natural non-allergenic substance, a fine powdered sugar, generally referred to as icing sugar, is a preferred sweetener. From about 6%-8.5% by weight of icing sugar is preferred as it appears to participate in binding as well sweetening the composition. Corn syrup, high fructose corn syrup and dextrose/glucose can also be used as sweeteners. From about 8%-8.8% Maltodextrin has been found to be particularly preferred, the Maltodextrin appearing to function not as a sweetener but as a carbohydrate and binder. There is very little taste or sweetness added to the p-butter using the Maltodextrin.

A variety of fruit/vegetable oils can be used can be used to control viscosity, however, for the purpose of formulating the faux peanut butter of the invention, palm oil is preferred. Palm oil affects viscosity by providing a stiff spreadable viscosity to the composition from low temperatures through high temperatures and retains the spreadability of the composition through temperatures up to about 102 degrees Fahrenheit. The viscosity affecting characteristic of palm oil in the composition allows the faux peanut butter to be injected, whipped as a topping or spread as a topping.

Non-hydrogenated shortenings such as liquid canola oil, modified palm kernel oil and the like, in amounts of about 2%-5% by weight of the composition can be added as emulsifiers, binders and flavoring within the composition. Salt is used as a flavor and preferably comprises about 0.10%-0.30% percent by weight of the composition.

The ingredients of the composition are mixed together to produce a light brown to dark brown paste. The paste is mixed and blended for approximately 15 minutes to one hour at from about 100 to about 140 degrees Fahrenheit until it reaches a consistent color and blend. The thoroughly mixed and blended paste is then poured into suitable container for sale and allowed to cool from its elevated temperature to about room temperature, about 65-70 degrees Fahrenheit at which temperature the container is sealed. The sealed container retains the faux peanut butter in a stable form and can be stored at room temperature without noticeable signs of separation of the components. Once opened, the faux peanut butter is preferably refrigerated, but such is not required. Unrefrigerated, the opened container may have slight oil separation on top if stored at temperatures exceeding about 95 degrees Fahrenheit, a condition which can be quickly resolved by stirring the composition. The separation is closely similar to separation of oils from ordinary peanut butter at such high temperatures.

The faux peanut butter of the invention has a very strong resemblance in color, appearance, flavor, taste and smell of peanut butter but contains no peanuts nor apparent allergens. The composition is considered natural/organic and can be consumed by persons who have allergies to peanuts or tree nuts. The composition does not contain any gluten or milk products or proteins and can be consumed by persons with celiac disease.

The composition of the present invention may be used in the preparation of food or as an ingredient in other food items. Embodiments include candy, for example, faux peanut butter covered with chocolate, brownies, cakes or other baked goods, filling in sandwiches or crackers, etc.

What is claimed:

1. A food composition mimicking peanut butter, comprising peas and at least one viscosity controlling component selected from palm oil, palm kernel oil and mixtures thereof.

2. The food composition of claim 1 comprising a sweetener.

3. The food composition of claim 2 wherein said sweetener is selected from the group consisting of brown sugar, white bleached sugar, powdered sugar, corn syrup, dextrose, glucose, multodextrin and mixtures thereof.

4. The food composition of claim 1 comprising a flavoring component.

5. The food composition of claim 2 comprising a flavoring component.

6. The food composition of claim 5 wherein said flavoring component comprises Canola oil.

7. The food composition of claim 1 wherein said peas are selected from the group consisting of solido brown pea, chickpea and mixtures thereof.

8. The food composition of claim 7 wherein said peas comprise from about 20% to about 60% by weight of the composition.

9. The food composition of claim 5 wherein said peas are selected from the group consisting of solido brown pea, chickpea and mixtures thereof; said sweetener is selected from the group consisting of brown sugar, white bleached sugar, dextrose and mixtures thereof; and said flavoring component comprises Canola oil.

10. The food composition of claim 9 comprising from about 20% to about 60% by weight peas; from about 4% to about 10% by weight viscosity controlling component; from about 1% to about 10% by weight sweetener; and from about 20% to about 40% by weight flavoring component.

11. The food composition of claim 10 comprising from about 30% to about 50% by weight peas; from about 4% to about 10% by weight viscosity controlling component; from about 5% to about 9% by weight sweetener; and from about 30% to about 40% by weight flavoring component.

12. The food composition of claim 11 comprising from about 42% to about 44% by weight peas and from about 5% to about 9% by weight of a sweetener selected from the group of powdered sugar, multodextrin and mixtures thereof.

13. A method for preparing a food composition mimicking peanut butter, comprising:
husking and thereafter roasting to at least a tan color peas selected from solido brown peas, chickpeas and mixtures thereof;
forming a mixture comprising from about 20% to about 60% by weight of said peas, from about 4% to about 10% by weight viscosity controlling component, from about 1% to about 10% by weight sweetener, and from about 20% to about 40% by weight flavoring component; and,
mixing and blending said mixture for about 15 to about 90 minutes at from about 100 to about 140 degrees Fahrenheit.
